(19) United States
(12) Patent Application Publication
(10) Pub. No.: US 2003/0231703 A1
(43) Pub. Date: Dec. 18, 2003

(54) Rake receiver delay line design

(75) Inventor: Nico Lugil, Rotselaar (BE)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 10/424,484

(22) Filed: Apr. 28, 2003

(30) Foreign Application Priority Data
Jun. 17, 2002 (EP) 02254221.1

(51) Int. Cl. H04B 1/707

(52) U.S. Cl. 375/148

(57) ABSTRACT

The present invention is related to a method for positioning fingers of a spread spectrum rake receiver, comprising the steps of:

Providing a delay line arranged to provide time shifted versions of an input signal,

Providing a switch arranged to select appropriate time shifted versions of said input signal to provide output signals with a predetermined resolution,

characterised in that the method further comprises the steps of

Applying an interpolation method to said selected output signals, selected by applying a controllable interpolation procedure, to produce an instance of a time shifted multipath signal with a resolution larger than or equal to said predetermined resolution, and

Providing to said fingers said instance of a time shifted multipath signal.

### FIELD OF THE INVENTION

The present invention is related to a receiver for IMT-2000 spread-spectrum signals, more particularly to a novel structure for a rake for such a receiver.

### STATE OF THE ART

When a signal is transmitted over a wireless channel, reflections of this transmitted signal on different objects will lead to identical signals with various and variable strength and phase. The receiver can and will receive these different reflections. Not all reflections will arrive at the same time (i.e. the path TX-reflection-RX is almost always different for different reflections, leading to phase difference). In the same way, as the path travelled by every signal can be different, the signal strength will vary. The receiver will thus receive time shifted versions of the same transmitted signal. A multipath is the sum of separate reflections with about the same Tx/Rx delay. As those multipaths are the sum of all signals arriving at the receiver at about the same moment, a very small shift of receiver position can change the phase and amplitude of each multipath considerably, because the separate signals the multipath signal is consisted of will change phase, leading to more or less signal extinction due to phase difference of the individual paths. This can result in a dramatic change in phase and amplitude of the combined multipath when the receiver is moved.

Since the phase and amplitude and delay of every multipath are changing in time, high quality signal reception is cumbersome, especially for the mobile user.

When CDMA is used for transmission/reception, the multipaths that have a phase difference of more than about the length of 1 chip are typically detectable separately (assuming good auto correlation properties of the CDMA code).

The purpose of a rake receiver, usually comprised in a CDMA receiver apparatus, is to combine coherently the multipaths to increase the receiver performance. To do a coherent combining a channel estimation and correction is needed per multipath. Traditional rakes thus comprise searchers (to search new multipaths), multipath trackers (used for following a shifting multipath signal) and combiner fingers (combining comprises to perform channel estimation, channel correction and to make the estimated and corrected signal available for adding to the final, combined signal so that the different channel corrected streams can be combined in a coherent way with the appropriate gain). The signals captured by the combiner fingers are combined to a combined strong signal in a coherent way.

When a CDMA signal is transmitted, every symbol is transmitted as a sequence of chips at a much higher rate than the symbol rate. This sequence of chips is called a PN code. The receiver will regenerate this PN code to detect the symbols. This regenerated PN code must be aligned with the incoming PN code, i.e. the receiver must know the phase of the incoming PN codes, which is not the case when the CDMA receiver is just turned on.

The goal of the chip time acquisition is to recover this phase at the receive side. This can be done for example by trying all possible phases and observing which possibility returns the best result (=most energy).

The current rakes as used in receivers have a delay line to align multipaths with each other and with the rake fingers. The input from the fingers can come from some specific point in the delay line, depending on the time shift of the multipath. As the delays between the multipaths are random and not merely e.g. multiples of the chiplength, the best performance can be obtained when alignment of the multipaths with the fingers and with each other is optimal. This can be case if the resolution of the delay line is very high. Further, the delay line needs to have a certain length (a multitude of the chip length) in order to capture the maximal useful delay between the multipaths.

Evidently, a rake receiver has to be implemented at least partly in hardware, therefore it is a factor that influences the overall production cost and it also has implications for battery life in mobile receivers. For a fixed length (in time or in chips), the resolution of the delay line is directly correlated with the number of elements that have to be in the delay line. Further, a higher resolution also means a higher clock rate for the delay line. Typically, a minimum of 4 times oversampling (4 times the chip speed) needs to be used for the delay line to obtain acceptable results. A prior art delay line is thus an important hardware cost factor and uses a lot of battery power, both of which are negative factors when designing mobile telecommunication devices.

### AIMS OF THE INVENTION

The present invention aims to provide a novel more efficient way of multipath signal combining to produce an enhanced signal. In particular, the present invention wishes to provide a cheaper spread spectrum receiver design while at least maintaining signal reception quality.

### SUMMARY OF THE INVENTION

The present invention concerns mainly a method for positioning fingers of a spread spectrum rake receiver, comprising the steps of:

Providing a delay line arranged to provide time shifted versions of an input signal,

Providing a switch arranged to select appropriate time shifted versions of said input signal to provide output signals with a predetermined resolution,

Applying an interpolation method to the selected output signals, selected by applying a controllable interpolation procedure, to produce an instance of a time shifted multipath signal with a resolution larger than or equal to the predetermined resolution, and

Providing to the fingers the instance of a time shifted multipath signal.

The controllable interpolation may comprise the steps of:

Setting some fingers in tracking or searching mode,

Selecting said output signals from the switch as input signal to the fingers in tracking or searching mode,

Despreading said input signal to the fingers in tracking or searching mode,

Calculating the energy in the despread signal in each of the fingers in tracking or searching mode,

Based on said energy calculations deciding on switch and interpolator settings allowing said switch to select appropriate time shifted versions and selecting an interpolation method.

The method of the present invention can be further characterised in that the selected output signals are adjacent, non-interpolated signals.

The interpolation method can be a linear, quadratic, or exponential interpolation of the selected output signals, or any other known interpolation method.

Another embodiment of the present invention is an integrated circuit comprising means for implementing the method of the present invention.

A further embodiment of the present invention is a computer program product arranged for execution on a computer device of all the steps of the method of the present invention.

The present invention further comprises a rake receiver comprising means for executing all steps of the method of the present invention.

Another embodiment of the present invention is a spread spectrum receiver comprising means for executing all steps of the method of the present invention.

### SHORT DESCRIPTION Of THE DRAWINGS

FIG. 1 represents a rake receiver design as known from the prior art.

FIG. 2 shows a rake receiver design comprising interpolation as in the present invention.

FIG. 3 shows the operation of the controller.

### DETAILED DESCRIPTION OF THE INVENTION

The present invention is related to a novel way of using delay lines in rake receivers.

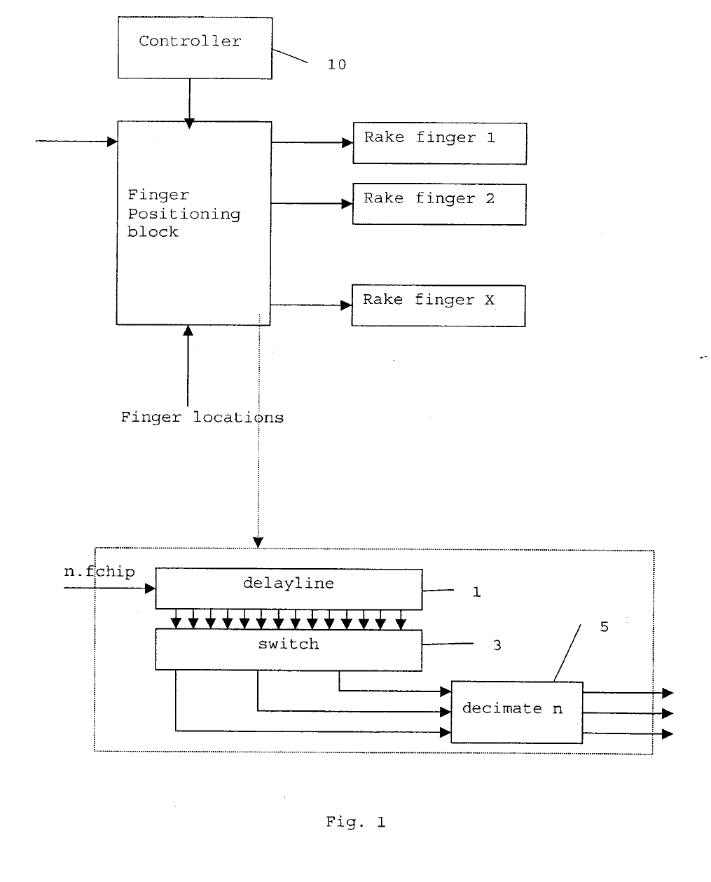

As explained higher, a prior art rake receiver comprises a delay line 1 as shown in FIG. 1. The delay line 1 takes the incoming signal (a superposition of time shifted multipaths). The fingers will take as input some point in the delay line in order to align the finger with the multipath. The delay line's clock frequency is a multiple n of the chip rate (fchip), usually n being 4 or 8. This way, acceptable resolution of the delay line is obtained. A switch allows each finger to choose where it will take its input from the delay line and the clock frequency is decimated to the original chip rate (5).

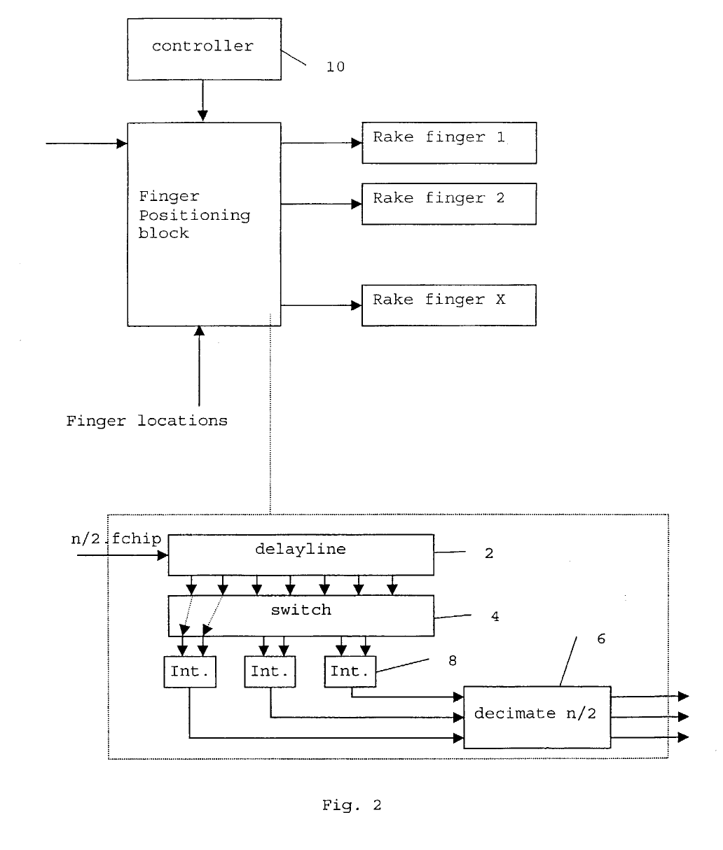

The rake receiver according to the invention can be seen schematically in FIG. 2. The delay line 2 is e.g. only clocked at half the speed of the prior art delay line (n/2. fchip). Two adjacent outputs of the delay line 2 can be interpolated (8) after switch 6 to obtain a combined signal, which in this example has to be decimated by n/2 (6) to obtain a signal at the chip rate fchip.

An example of an interpolation method is now provided. In this setup a simple linear interpolation is used. Interpolated samples are calculated as follows:

Interpolated sample=a*xᵢ+(1−a)*xᵢ₊₁ (formula1)

where xᵢ and xᵢ₊₁ are 2 consecutive samples and ‘a’ is a number in the range [0:1]. In typical implementations the value that ‘a’ can take will be limited to some discrete values. Any other interpolation method can be used, i.e. other formula, or higher order.

The interpolation is performed in a controlled manner. The inputs of the interpolators are determined by the controller block (10), that controls the combining of the selected output signals by means of a switch. The controller also determines the operation mode of the interpolator (i.e. the interpolation point). The controller block can easily be realised in software. All interpolators are controlled individually.

The controller operation is now described in a more detailed way.

The controller controls the switch and the interpolator operation, i.e. the selection of the interpolation method. The interpolation can for example be done by just passing one of the several interpolator inputs or the average of the interpolator inputs or any other combination.

Some of the fingers are positioned on adjacent and non-interpolated positions. This can be done either by several fingers in parallel or one finger observing sequentially different positions or something in between. In this step the interpolator is set by the controller such that the interpolator will just pass through one of the inputs in a defined way, without interpolating. In this way only non-interpolated positions are passed to the finger. In the RAKE finger the input is despread with the PN code present on the signal and an energy is calculated based on the despread output. This energy is passed to the controller. These fingers do not contribute to the RAKE combining but are used in a searching or tracking mode.

The controller decides based on these adjacent, non-interpolated energy values where the finger to be combined in the RAKE process, must ideally be positioned. This means the controller algorithm determines the ideal switch setting and also the ideal interpolator operation. Different algorithms can be used depending on the needs, the transmitted waveform, etc. The algorithm is based on comparing the energies of the adjacent, non-interpolated positions. E.g. in the case of a linear interpolator with 2 inputs (xᵢ and xᵢ₊₁ (non-interpolated)) and 2 operation modes: out=xᵢ (i.e. a=1 in formula1) or out=(xᵢ+xᵢ₊₁)/2 (i.e a=0.5) If Xᵢ is almost equal to xᵢ₊₁, the incoming signal is probably in between the 2 non-interpolated and the chosen interpolation mode is out=(xᵢ+xᵢ₊₁)/2, which is then passed to the combining finger. In case Xᵢ is much larger than xᵢ₊₁, the interpolator will output xᵢ as such. In case of higher interpolation orders more complex algorithms and more decision variables are to be used.

Instead of only observing non-interpolated positions it is also possible to base the algorithm on interpolated positions, but this is more complex.

Once a finger that is combined is positioned, the paths may move. Therefore the described process regularly is repeated. If needed, the combining finger position is adjusted (by changing the switch setting and interpolator operation). The main advantage of having a controllable interpolator is that the combining finger is always positioned at the most ideal position.

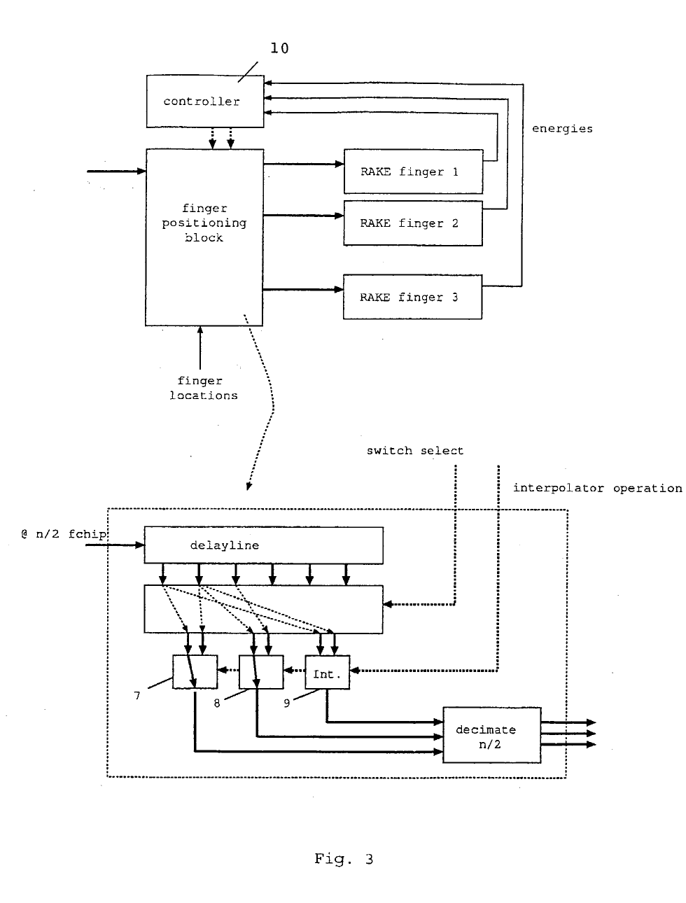

FIG. 3 illustrates the controller operation. A signal has been found and RAKE finger 1 is assigned as combining finger. The input of finger 1 comes via interpolator (9). At this time it is being examined what the ideal interpolator operation should be. It is assumed that by previous analysis it is known that the multipath is somewhere between the first and second output of the delay line. Finger 2 and 3 are used to look at delay line output 1 and 2 respectively. This is done by setting the switch as depicted in the figure and by setting the interpolators (7) and (8) to a mode in which they just pass the leftmost input. The energies that come out of finger 2 and 3 are sent to the controller and the controller will decide based on this how to control the interpolator (9).

Influence of Sampling Instant Resolution on Bit Error Rate (BER)

In a CDMA system it is important to sample the chip stream at the correct moment in time. In this way the locally generated code is best aligned with the incoming code and the best BER is obtained.

The following table illustrates the effect of missampling and the usage of an interpolator. The simple linear interpolator is used in this setup. For the different tests the BER was compared with the BER of ideal sampling and the difference was translated in an equivalent implementation loss using the BPSK Eb/No vs. BER curve.

A typical PN code and Eb/No were used.

| | | |
|---|---|---|
| Loss by missampling half chip | 3 | dB |
| Loss by missampling 0.25 chip | 0.93 | dB |
| Loss by interpolating between half chip before and | 1 | dB |
| after the ideal sampling moment | | |
| Loss by interpolating between 0.25 chip before and | 0.06 | dB |
| after the ideal sampling moment | | |

So it would mean that if one keeps the resolution of the delay line half chips and do nothing else (i.e. maximum error=0.25 chip), one could have a loss of 0.93 dB (worst case).

Now by not doubling the delay line, but only introducing the interpolation, one can reduce this 0.93 dB loss to 0.06 dB.

1. Method for positioning fingers of a spread spectrum rake receiver, comprising the steps of:
Providing a delay line arranged to provide time shifted versions of an input signal,
Providing a switch arranged to select appropriate time shifted versions of said input signal to provide output signals with a predetermined resolution,
Applying an interpolation method to said selected output signals, selected by applying a controllable interpolation procedure, to produce an instance of a time shifted multipath signal with a resolution larger than or equal to said predetermined resolution, and
Providing to said fingers said instance of a time shifted multipath signal.

2. Method as in claim 1, wherein the controllable interpolation procedure comprises the steps of:
Setting some fingers in tracking or searching mode,
Selecting said output signals from the switch as input signal to the fingers in tracking or searching mode,
Despreading said input signal to the fingers in tracking or searching mode,
Calculating the energy in the despread signal in each of the fingers in tracking or searching mode,
Based on said energy calculations deciding on switch and interpolator settings allowing said switch to select appropriate time shifted versions and selecting an interpolation method.

3. Method as in claim 2, wherein the selected output signals are adjacent, non-interpolated signals.

4. Method as in claim 1, wherein said interpolation method is a linear, quadratic, or exponential interpolation of said selected output signals.

5. An integrated circuit comprising means for implementing the method of any of the claims 1 to 4.

6. A computer program product arranged for execution on a computer device of all the steps of any of the claims 1 to 4.

7. A rake receiver comprising means for executing all steps of the method as in any of the claims 1 to 4.

8. A spread spectrum receiver comprising means for executing all steps of the method as in any of the claims 1 to 4.
